(19) United States
(12) Patent Application Publication
(10) Pub. No.: US 2015/0249377 A1
(43) Pub. Date: Sep. 3, 2015

(54) LINER STEPPER MOTOR HAVING ANTI-ROTATION SCREW

(71) Applicant: SHANGHAI MOONS' ELECTRIC CO., LTD., Shanghai (CN)

(72) Inventors: Kai ZENG, Shanghai (CN); Yongsong WU, Shanghai (CN)

(21) Appl. No.: 14/698,564

(22) Filed: Apr. 28, 2015

Related U.S. Application Data
(63) Continuation of application No. PCT/CN2013/085557, filed on Oct. 21, 2013.

(30) Foreign Application Priority Data
Oct. 31, 2012 (CN) 201210428066.1

(51) Int. Cl. H02K 7/06; H02K 37/00; F16H 25/24

(52) U.S. Cl. CPC H02K 7/06; F16H 25/24; H02K 37/00; F16H 2025/204

(57) ABSTRACT

A linear stepping motor having anti-rotating screw is disclosed, comprising a stator, a rotor, a front-end cover, a rear-end cover and a screw, wherein the screw is an anti-rotating screw. The anti-rotating screw comprises a screw main body, one end of the screw main body is covered with a layer of plastic anti-rotating structure of injection molding. The front-end cover is provided with a segment of inner cavity, which is of shape matched with the anti-rotating structure, and the anti-rotating structure of the screw is in sleeved connection with the inner cavity of the front-end cover. The linear stepping motor in the present invention has the advantages in that the screw is free from limits in the processing length, has high strength, keeps high concentricity and other accuracy, and is of small error in use and less processing procedures, and saves working time. Less metallic profiles are consumed, energy is saved and the injection molding structure has a self-lubricating function, and when cooperating with the motor to perform linear motion, has a high efficiency and a long service life.

### BACKGROUND OF THE INVENTION

1. Technical Field

The present invention relates to a motor, in particular to a linear stepping motor having anti-rotating screw.

2. Description of Related Art

Linear stepping motor is a motor, which converts rotary motion into linear motion through a screw. For a common linear stepping motor, the rotor which performs rotary motion has an internal screw thread structure and then is sleeved with a sleeve, so that the motor drives the screw to move backward and forward when rotating. However, if there is no mechanism, which prevents the screw from rotating, the screw will inevitably rotate along with the rotor, thus failing to achieve the linear motion effect. To prevent the screw from rotating, usually two methods are employed. One is fixing the screws by using nut outside the motor, and the other is directly setting a screw anti-rotating structure on the motor main body. The second method realizes the linear motion of the screw because the motor main body is provided with the fixing mechanism instead of using an external fixing mechanism, thus having advantages of high stability, high applicability, controllability and operability.

To realize the anti-rotation of the screw on the motor main body, in the prior art, another segment of shaft with a radial anti-rotating shape is manufactured, called anti-rotating shaft, for example, shaft with a boss, a flat thread or in polygonal shape. FIG. 1 shows a rotating shaft 1 with a boss 11. Or, the shaft head is provided with a pin and other parts to prevent rotation, and then the processed screw 2 is welded or glued with the anti-rotating shaft 1 (as shown in FIG. 2, 21 refers to a welding place). In addition, the motor main body (for example, the front-end cover 3) is formed with a portion 31 (see FIG. 3) matched with the anti-rotating shaft 1 such that the anti-rotating shaft is clamped between the portion of the end cove which is matched with the anti-rotating shaft, thus the screw can only do the linear motion and cannot perform radial rotation. In the prior art, the basic structure of the linear stepping motor can be seen in FIG. 4. As shown in the figure, 1, anti-rotating shaft; 2, screw; 3, front-end cover; 4, shaft 4; 5, rotor; 6, stator; 7, rear end cover.

There are following problems in the prior art:

1. The screw and the anti-rotating shaft are separately processed, and during batch production, only a small segment of screw can be processed, so the production efficiency is low.

2. The screw and the anti-rotating shaft are connected through welding or gluing, so the strength is poor.

3. The screw and the anti-rotating shaft are separately processed, so the concentricity and other accuracy of the shaft after joining are relatively poor, so a relatively large error is generated in use.

4. After processing of the screw, a more segment of anti-rotating shaft shall be processed, and the anti-rotating shaft must under cutting processing to form an anti-rotating shape, so excessive metal materials and energy are consumed, and a more welding (gluing) procedure is generated.

5. The metal anti-rotating shaft is seriously worn after moving relative to the motor, so its efficiency and working service life are not desirable.

### BRIEF SUMMARY OF THE INVENTION

The objective of the present invention is to provide a linear stepping motor having anti-rotating screw to solve the problems in the prior art.

To fulfill the above objective, the present invention employs the following technical solution: a linear stepping motor having anti-rotating screw comprises a stator, a rotor, a front-end cover, a rear-end cover and a screw. The screw is an anti-rotating screw, the anti-rotating screw comprises a screw main body. One end of the screw main body is covered with a layer of plastic anti-rotating structure of injection molding and the screw is in sleeved and sliding connection with the front-end cover.

The plastic anti-rotating structure is polygonal, boss-shaped or flat-thread shaped.

The plastic anti-rotating structure is hexagonal.

Employing the above technical solution, the linear stepping motor in the present invention has the following advantages and characteristics:

1. The processing length of the screw is not limited, and the screw can be produced in batch through flat-rolling, thus greatly improving the production efficiency.

2. The screw and the anti-rotating structure are integrated, ensuring high strength.

3. The injection molding structure is integrally molded and integrated with the screw as a whole, keeping high concentricity and other accuracy and generating small error in use.

4. Less processing procedures are needed, saving the working time; and less metal profiles are consumed, saving energy.

5. The injection molding structure has a self-lubricating function, and when cooperating with the motor to perform the linear motion, has a high efficiency and a long service life.

### BRIEF DESCRIPTION OF THE SEVERAL VIEWS OF THE DRAWINGS

FIG. 1 is a structural view of a rotating shaft in the prior art;

FIG. 2 is a structural view of a combination of a rotating shaft and a screw in the prior art;

FIG. 3 is a structural view of a front-end cover in the prior art;

FIG. 4 is a schematic view of the basic structure of a linear stepping motor in the prior art;

FIG. 5 is a structural view of an anti-rotating screw in the present invention;

FIG. 6 is a schematic view of the basic structure of a linear stepping motor in the present invention;

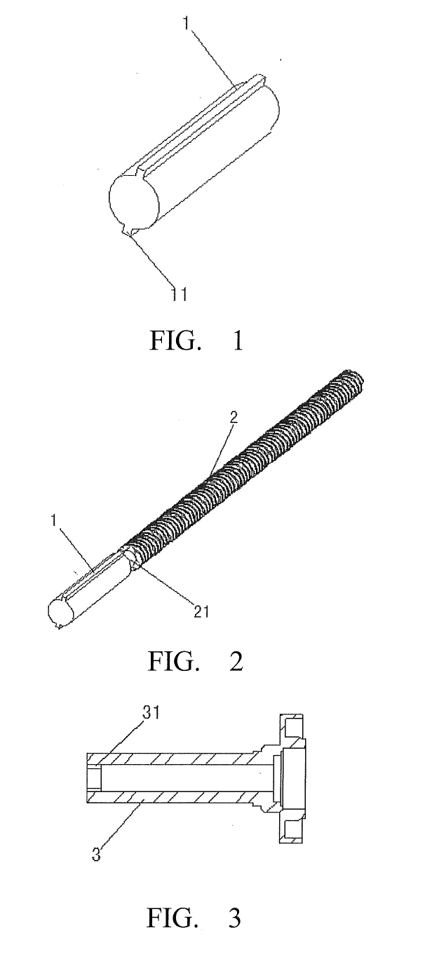

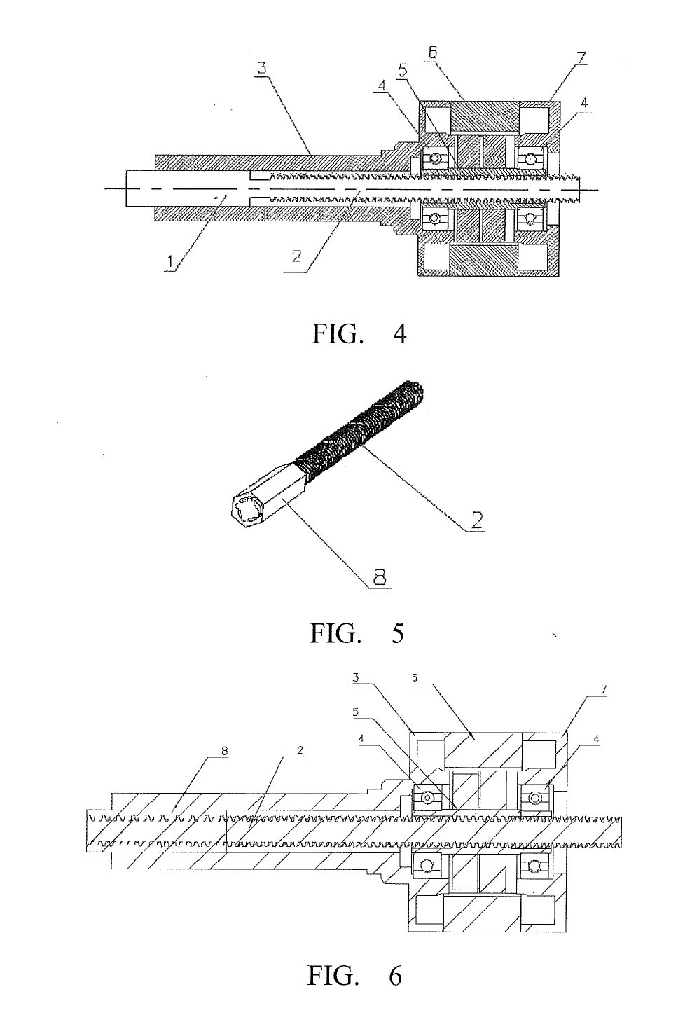

### DETAILED DESCRIPTION OF THE INVENTION

Refer to FIGS. 5 and 6. In the present invention, a linear stepping motor having anti-rotating screw comprises a stator 6, a rotor 5, a front-end cover 3, a rear-end cover 7, a screw 2 and a bearing 4. Wherein, the screw 2 is an anti-rotating shaft, the anti-rotating screw comprises a screw main body. One end of the screw main body is covered with a layer of plastic anti-rotating structure 8 of injection molding; the screw is in sleeved and sliding connection with the front-end cover through the anti-rotating structure, and the screw can axially move along the front-end cover without radial rotation.

The plastic anti-rotating structure in the present invention is polygonal, boss-shaped or flat-thread shaped.

The plastic anti-rotating structure in the present invention is a hexagonal in a preferable embodiment.

What is claimed is:

1. A linear stepping motor having anti-rotating screw, comprising a stator, a rotor, a front-end cover, a rear-end cover and a screw, characterized in that the screw is an anti-rotating screw. The anti-rotating screw comprises a screw main body, one end of the screw main body is covered with a layer of plastic anti-rotating structure of injection molding and the screw is in sleeved and sliding connection with the front-end cover.

2. The linear stepping motor according to claim 1, wherein the plastic anti-rotating structure is polygonal, boss-shaped or flat-thread shaped.

3. The linear stepping motor according to claim 1, wherein the plastic anti-rotating structure is hexagonal.
